(19) United States
(12) Patent Application Publication
(10) Pub. No.: US 2018/0094454 A1
(43) Pub. Date: Apr. 5, 2018

(54) SLIDING WINDOW AND DOOR LOCK

(71) Applicant: JORGE LUIS CHAVEZ, DALLAS, TX (US)

(72) Inventor: JORGE LUIS CHAVEZ, DALLAS, TX (US)

(21) Appl. No.: 15/286,469

(22) Filed: Oct. 5, 2016

(51) Int. Cl. E05B 45/00; E05B 39/00; E05C 3/12; E05B 65/08

(52) U.S. Cl. CPC E05B 45/00; E05B 39/00; E05B 2045/063; E05B 65/0841; E05C 3/12

(57) ABSTRACT

A sliding window and door lock including: A housing, where the housing is attached to at least one of a window sill and the floor next to a sliding door; a pivoting latch and a pivot, where the pivot attaches the pivoting latch to the housing, where the pivot is located farther along the path of travel of the at least one of a sliding window and sliding door when the housing is mounted to the at least one of a window sill and the floor, wherein the pivoting latch is adapted to pivot from being flush with the edge of the housing into the path of travel of the at least one of a sliding window and a sliding door, wherein the edge of the pivoting latch interfaces with the at least one of a sliding window and a sliding door, wherein the force of the at least one of a sliding window and sliding door would be obstructed by the pivoting latch being forced into the pivot. The sliding window and sliding door lock is preferably designed to at least one of 1) provide a lock to obstruct the opening of either of a sliding window and a sliding door, 2) prop open either of a sliding window and a sliding door, 3) create an alarm if an intruder attempts to open either of a sliding window and a sliding door.

### BRIEF DESCRIPTION OF THE FIGURES

FIG. 1 is a schematic representation of the system of the first preferred embodiments.

FIG. 2 is a schematic representation of the system of the first preferred embodiments, where the lock also includes at least one of a switch and a force sensor, and at least one of a light bulb, an LED light, a speaker, a sound emitting device, and a wireless alarm.

### DESCRIPTION OF THE PREFERRED EMBODIMENTS

The description that follows of the invention's preferred embodiments is meant to enable someone skilled in the prior art to make and use the invention, but is not meant to limit the invention to these preferred embodiments.

### 1. First Preferred Embodiment

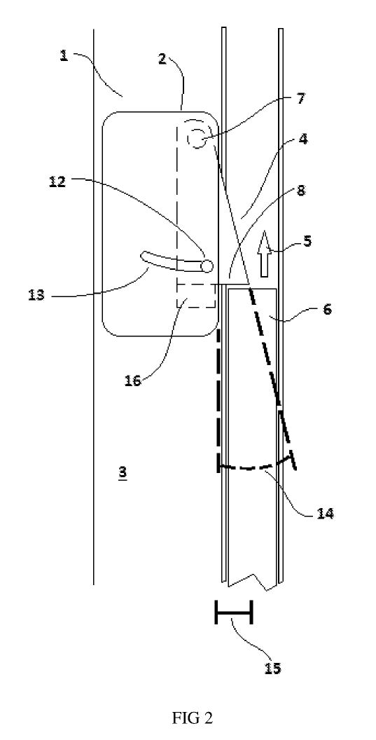

As shown in FIG. 1, the system of the preferred embodiments is a sliding window and door lock 1 including: A housing 2, where the housing 2 is attached to at least one of a window sill 3 and the floor 3 next to a sliding door; a pivoting latch 4 and a pivot, where the pivot 7 attaches the pivoting latch 4 to the housing 2, where the pivot 7 is located farther along the path of travel 5 of the at least one of a sliding window and sliding door 6 when the housing 2 is mounted to the at least one of a window sill 3 and the floor 3, wherein the pivoting latch 4 is adapted to pivot 7 from being flush with the edge of the housing 2 into the path of travel 5 of the at least one of a sliding window and a sliding door 6, wherein the edge 8 of the pivoting latch 4 interfaces with the at least one of a sliding window and a sliding door 6, wherein the force of the at least one of a sliding window and sliding door 6 would be obstructed by the pivoting latch 4 being forced into the pivot. The sliding window and sliding door 6 lock is preferably designed to at least one of 1) provide a lock to obstruct the opening of either of a sliding window and a sliding door 6, 2) prop open either of a sliding window and a sliding door 6, 3) create an alarm if an intruder attempts to open either of a sliding window and a sliding door 6.

As shown in FIG. 1, the pivoting latch 4 is attached to a pivot 7 which is further along the direction of travel of either of a sliding window and a sliding door 6, so that when the pivoting latch 4 is pivoted outwards from the housing 2, the edge 8 of the pivoting latch 4 protrudes into the path of travel 5 of either of the sliding window and the sliding door. If either of the sliding window and the sliding door is opened into the edge 8 of the pivoting latch 4, it transmits force into the pivot 7 and into the housing 2. Because the housing 2 is attached to at least one of the window sill 3, the floor 3, and a wall, this obstructs the path of either of the sliding window and sliding door 6 and locks it from opening at least one of A) at all, and B) past a certain point. As shown in FIG. 1, the pivot angle 14 of the pivoting latch 4 when it is opened fully into the path of either of a sliding window and a sliding door 6 preferably does not exceed 30 degrees 14. The edge 8 of the pivoting latch 4 preferably extends at least 0.5 inches 15 into the path of either of the sliding window and the sliding door. The pivoting latch 4 may, however, pivot 7 to any suitable 16 angle and extend any suitable 16 distance to sufficiently block at least one of a sliding window and a sliding door 6. In one preferred variation, the sliding window and door lock 1 further includes a spring attached to the latch, so that the latch is spring-loaded to bias it into its outward and locked position, so that it locks at least one of a sliding door and window automatically as soon as the at least one of a door and window moves past the sliding window and door lock 1. There may, however, be no spring at all.

As shown in FIG. 1, there is preferably a groove 13 in the housing 2, where at least one of a pin 12, a knob 12, a handle 12, and a textured pad 12 that extends through the groove 13 and attaches to the pivoting latch 4. This provides a user a way to pivot 7 the pivoting latch 4 from the exterior of the housing 2. There may, however, be any suitable 16 means for pivoting the latch into and out of the housing 2.

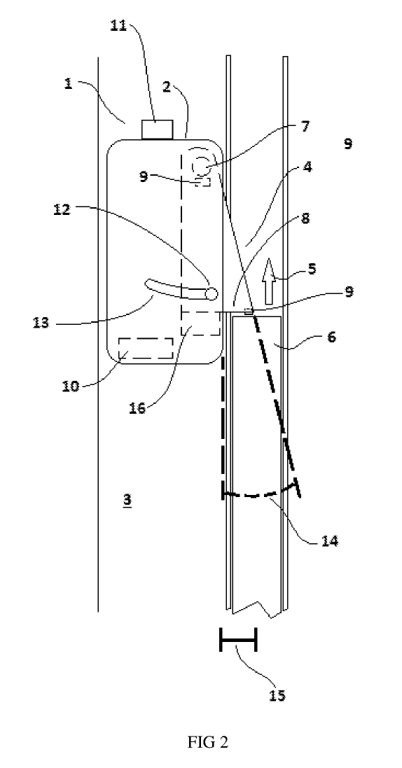

As shown in FIG. 2, in a preferred variation there is at least one of a switch 9 and a force sensor 9 attached to the pivoting latch 4. In this variation, the at least one of a switch 9 and a force sensor 9 preferably provides power from the power source 10 to at least one of a light bulb 11, an LED light 11, a speaker, a sound emitting device 11, and a wireless alarm 11 when at least one of A) the switch 9 is tripped by the movement of either of a sliding window and a sliding door 6, and B) the force sensor 9 senses at least a certain amount of force exerted on the pivoting latch 4 by the movement of either of the sliding window and the sliding door. This variation preferably creates an alarm if an intruder attempts to open the at least one of a sliding window and a sliding door 6. In a further variation, a switch 9 is attached to the edge 8 of the pivoting latch 4, where it will be tripped if either of the sliding window and sliding door 6 is opened into contact with the edge 8 of the pivoting latch 4 that obstructs either of the sliding window and sliding latch. The power source 10 can be at least one of a battery, a connection to a power outlet, and any other suitable 16 source of power to the alarm. In one variation with a wireless alarm, a user's mobile device may receive a wireless signal and notify the user. There may, however, be any suitable 16 form of alarm, it may use any suitable 16 method to trigger the alarm, and the alarm may be any suitable 16 method for alerting a user of an attempt to open either of the sliding window and the sliding door. There may, however, be no alarm at all.

As shown in FIG. 1, in a preferred variation a tab 16 is attached to the pivoting latch 4, where the tab 16 is designed to prevent the pivoting latch 4 from pivoting past a maximum pivot angle 14 out of the housing 2. This preferably prevents force exerted on the pivoting latch 4 by either of a sliding window and a sliding door 6 from forcing the pivoting latch 4 to pivot 7 outwards farther, which could allow either of a sliding window and a sliding door 6 to be forced open. The limited pivot angle 14 preferably also allows the pivot 7 latch to better transmit force from either of the sliding window and the sliding door to the pivot 7 and better obstruct the movement of at least one of a sliding window and a sliding door 6. In another preferred variation, the at least one of a pin 12, a knob 12, a handle 12, and a textured pad 12 prevents the pivoting latch 4 from pivoting outwards past a maximum pivot angle 14 because the at least one of a pin 12, a knob 12, a handle 12, and a textured pad 12 prevents protrudes through the groove 13 and the groove 13 blocks the pivoting latch 4 from pivoting further outward than a desired maximum angle. There may, however, be any suitable 16 means for holding the pivoting latch 4 in a position that impedes the movement of either of a sliding window and a sliding door 6.

In a preferred variation, the sliding window and door lock 1 can be used to prop open either of a sliding window and a sliding door 6 at a desired position. In one variation of this variation, the sliding window and door lock 1 can be mounted upside-down on a window sill 3, and the pivoting latch 4 can impede the downward motion of the sliding window. There may, however, be any suitable 16 use for the sliding window and door lock 1.

As a person skilled in the art will recognize from the previous detailed description and from the figures and claims, modifications and changes can be made to the preferred embodiments of the invention without departing from the scope of this invention defined in the following claims.

I claim:

1) A sliding window and door lock comprising: A housing, wherein the housing is attached to at least one of a window sill and the floor; a pivoting latch and a pivot, wherein the pivot attaches the pivoting latch to the housing, wherein the pivot is located farther along the path of travel of the at least one of a sliding window and a sliding door when the housing is mounted to the at least one of a window sill and the floor, wherein the pivoting latch is adapted to pivot from being flush with the edge of the housing into the path of travel of the at least one of a sliding window and a sliding door, wherein the edge of the pivoting latch interfaces with the at least one of a sliding window and a sliding door, wherein the force of the at least one of a sliding window and sliding door would be obstructed by the pivoting latch being forced into the pivot.

2) The sliding window and door lock of claim 1, wherein at least one of a switch attached to either end of the pivoting latch, and a force sensor adapted to sense force exerted on the pivoting latch is attached to a power source and to at least one of a light bulb, an LED light, a speaker, sound emitting device, and a wireless alarm, wherein if at least one A) of the switch is activated by at least one of the sliding window and the sliding door moving into the pivoting latch, and B) a force above a threshold is sensed by the force sensor due to the at least one of a sliding window and a sliding door moving into the pivoting latch, power is supplied to at least one of the light bulb, LED light, speaker, sound emitting device, and wireless alarm to create an alert that there may be an intruder attempting to open at least one of the sliding window and sliding door.

3) The sliding window and door lock of claim 1, further comprising a groove in the housing, wherein at least one of a knob, a pin, a handle, and a textured pad is attached through the groove to the pivoting latch, wherein the at least one of a knob, a pin, a handle, and a textured pad is adapted to provide the user a means to pivot the pivoting latch from the exterior of the housing, allowing the user to move the pivoting latch between an open and closed position.

4) The sliding window and door lock of claim 2, further comprising a groove in the housing, wherein at least one of a knob, a pin, a handle, and a textured pad is attached through the groove to the pivoting latch, wherein the at least one of a knob, a pin, a handle, and a textured pad is adapted to provide the user a means to pivot the pivoting latch from the exterior of the housing, allowing the user to move the pivoting latch between an open and closed position.

5) The sliding window and door lock of claim 3, wherein a switch is attached to the end of the pivoting latch, where it interfaces with at least one of the sliding window and sliding door, wherein the position of the switch is adapted to activate the switch if at least one of the sliding window and the sliding door is opened far enough to push against the pivoting latch.

6) The sliding window and door lock of claim 4, wherein a switch is attached to the end of the pivoting latch, where it interfaces with at least one of the sliding window and sliding door, wherein the position of the switch is adapted to activate the switch if at least one of the sliding window and the sliding door is opened far enough to push against the pivoting latch.

7) The sliding window and door lock of claim 1, wherein the pivoting catch pivots less than 30 degrees from a position that is flush with the side of the housing, to a position that obstructs the movement of the at least one of a sliding window and a sliding door, wherein the end of the pivoting latch protrudes at least 0.5 inches from the edge of the housing into the path of the at least one of a sliding window and a sliding door.

8) The sliding window and door lock of claim 2, wherein the pivoting catch pivots less than 30 degrees from a position that is flush with the side of the housing, to a position that obstructs the movement of the at least one of a sliding window and a sliding door, wherein the end of the pivoting latch protrudes at least 0.5 inches from the edge of the housing into the path of the at least one of a sliding window and a sliding door.

9) The sliding window and door lock of claim 3, wherein the pivoting catch pivots less than 30 degrees from a position that is flush with the side of the housing, to a position that obstructs the movement of the at least one of a sliding window and a sliding door, wherein the end of the pivoting latch protrudes at least 0.5 inches from the edge of the housing into the path of the at least one of a sliding window and a sliding door.

10) The sliding window and door lock of claim 4, wherein the pivoting catch pivots less than 30 degrees from a position that is flush with the side of the housing, to a position that obstructs the movement of the at least one of a sliding window and a sliding door, wherein the end of the pivoting latch protrudes at least 0.5 inches from the edge of the housing into the path of the at least one of a sliding window and a sliding door.

11) The sliding window and door lock of claim 5, wherein the pivoting catch pivots less than 30 degrees from a position that is flush with the side of the housing, to a position that obstructs the movement of the at least one of a sliding window and a sliding door, wherein the end of the pivoting latch protrudes at least 0.5 inches from the edge of the housing into the path of the at least one of a sliding window and a sliding door.

12) The sliding window and door lock of claim 6, wherein the pivoting catch pivots less than 30 degrees from a position that is flush with the side of the housing, to a position that obstructs the movement of the at least one of a sliding window and a sliding door, wherein the end of the pivoting latch protrudes at least 0.5 inches from the edge of the housing into the path of the at least one of a sliding window and a sliding door.

13) The sliding window and door lock of claim 7, wherein the pivoting latch further comprises a tab attached to the end of the pivoting latch that prevents the pivoting latch from pivoting further out of the edge of the housing, wherein the restricted pivot angle of the pivoting latch and the tab prevent the force of opening at least one of the sliding window and the sliding door from forcing the pivoting latch to pivot further out of the housing, and transmits the force from the at least one of the sliding window and the sliding door into the pivot.

14) The sliding window and door lock of claim 8, wherein the pivoting latch further comprises a tab attached to the end of the pivoting latch that prevents the pivoting latch from pivoting further out of the edge of the housing, wherein the restricted pivot angle of the pivoting latch and the tab prevent the force of opening at least one of the sliding window and the sliding door from forcing the pivoting latch to pivot further out of the housing, and transmits the force from the at least one of the sliding window and the sliding door into the pivot.

15) The sliding window and door lock of claim 9, wherein the pivoting latch further comprises a tab attached to the end of the pivoting latch that prevents the pivoting latch from pivoting further out of the edge of the housing, wherein the restricted pivot angle of the pivoting latch and the tab prevent the force of opening at least one of the sliding window and the sliding door from forcing the pivoting latch to pivot further out of the housing, and transmits the force from the at least one of the sliding window and the sliding door into the pivot.

16) The sliding window and door lock of claim 10, wherein the pivoting latch further comprises a tab attached to the end of the pivoting latch that prevents the pivoting latch from pivoting further out of the edge of the housing, wherein the restricted pivot angle of the pivoting latch and the tab prevent the force of opening at least one of the sliding window and the sliding door from forcing the pivoting latch to pivot further out of the housing, and transmits the force from the at least one of the sliding window and the sliding door into the pivot.

17) The sliding window and door lock of claim 11, wherein the pivoting latch further comprises a tab attached to the end of the pivoting latch that prevents the pivoting latch from pivoting further out of the edge of the housing, wherein the restricted pivot angle of the pivoting latch and the tab prevent the force of opening at least one of the sliding window and the sliding door from forcing the pivoting latch to pivot further out of the housing, and transmits the force from the at least one of the sliding window and the sliding door into the pivot.

18) The sliding window and door lock of claim 12, wherein the pivoting latch further comprises a tab attached to the end of the pivoting latch that prevents the pivoting latch from pivoting further out of the edge of the housing, wherein the restricted pivot angle of the pivoting latch and the tab prevent the force of opening at least one of the sliding window and the sliding door from forcing the pivoting latch to pivot further out of the housing, and transmits the force from the at least one of the sliding window and the sliding door into the pivot.
